(19) United States
(12) Patent Application Publication
(10) Pub. No.: US 2009/0287622 A1
(43) Pub. Date: Nov. 19, 2009

(54) System and Method for Active Learning/Modeling for Field Specific Data Streams

(76) Inventors: Harry Wechsler, Fairfax, VA (US); Shen-Shyang Ho, Pasadena, CA (US)

Correspondence Address: GEORGE MASON UNIVERSITY;OFFICE OF TECHNOLOGY TRANSFER, MSN 5G5, 4400 UNIVERSITY DRIVE, FAIRFAX, VA, 22030, US

(21) Appl. No.: 12/466,685

(22) Filed: May 15, 2009

Related U.S. Application Data
(60) Provisional application No. 61/053,350, filed on May 15, 2008.

(51) Int. Cl. G06F 15/18

(52) U.S. Cl. 706/12; 706/52; 707/104.1

(57) ABSTRACT

A system and method for determining whether at least one data point is interesting may be provided. The system may include, among other things, a memory for the at least one data point and a query-by-transduction module configured to assign a plurality of labels to the at least one data point, wherein each label among the plurality of labels corresponds to a respective classification for the at least one data point and wherein each label corresponds to a respective confidence metric that indicates a level of confidence that the respectively corresponding label accurately classifies the at least one data point, analyze the plurality of confidence metrics, and determine whether the at least one data point is interesting based on the analysis.

### CROSS-REFERENCE TO RELATED APPLICATIONS

This Application claims the benefit of U.S. Provisional Patent Application Ser. No. 60/053,350, filed May 15, 2008, which is hereby incorporated by reference herein in its entirety.

### BRIEF DESCRIPTION OF THE SEVERAL VIEWS OF THE DRAWINGS

FIG. 1 is a block diagram illustrating a system for active learning and modeling for field specific data streams according to an embodiment of the invention.

FIG. 2 is a block diagram illustrating a query-by-transduction module according to an embodiment of the invention.

FIG. 3 is a flow diagram of a process for generating an active learning training dataset according to an embodiment of the invention.

FIG. 4 is a flow diagram of a process for determining whether a data point is interesting according to an embodiment of the invention.

FIG. 5 is a flow diagram of a process for analyzing confidence metrics according to an embodiment of the invention.

FIG. 6 is a flow diagram of a process for terminating an active learning training session according to an embodiment of the invention.

FIG. 7 is a flow diagram of a process for terminating an active learning training session according to an embodiment of the invention.

FIG. 8 is a flow diagram of a process for selecting relevant data from among a plurality of data points related to a particular field according to an embodiment of the invention.

### DETAILED DESCRIPTION OF EMBODIMENTS

The embodiments described herein relate to a system and method for active learning and modeling for field specific data streams. According to various aspects of the embodiments, a system and method are used to actively learn from and model field-specific data. For example, the system may employ an active learning algorithm in order to learn from and model data. In particular, the system may use query-by-transduction as the active learning algorithm, which may be used to generate training data for classifying unlabelled data points. Based on whether data points are interesting, the system may selectively and iteratively add the data points to the training data until an appropriate stopping threshold is reached. Once the training data is generated, the system may use the training data in order to classify unlabelled data.

In operation, classifications of prior unlabelled data points may be used in a variety of applications. For example, in a stream-based setting, the system may observe streaming data points and dynamically classify the observed data points. In particular, among other applications in a stream-based setting, streaming video may be analyzed to detect changes to the streaming video (such as, for example, detecting scene changes in a movie and monitoring security/surveillance cameras). In a pool-based setting, the system may use the training data to select relevant data from a pool of data points. In particular, among other applications in a pool-based setting, relevant medical data points (such as from a patient's medical record) may be selected to assist medical diagnoses, prognoses, and care for a patient.

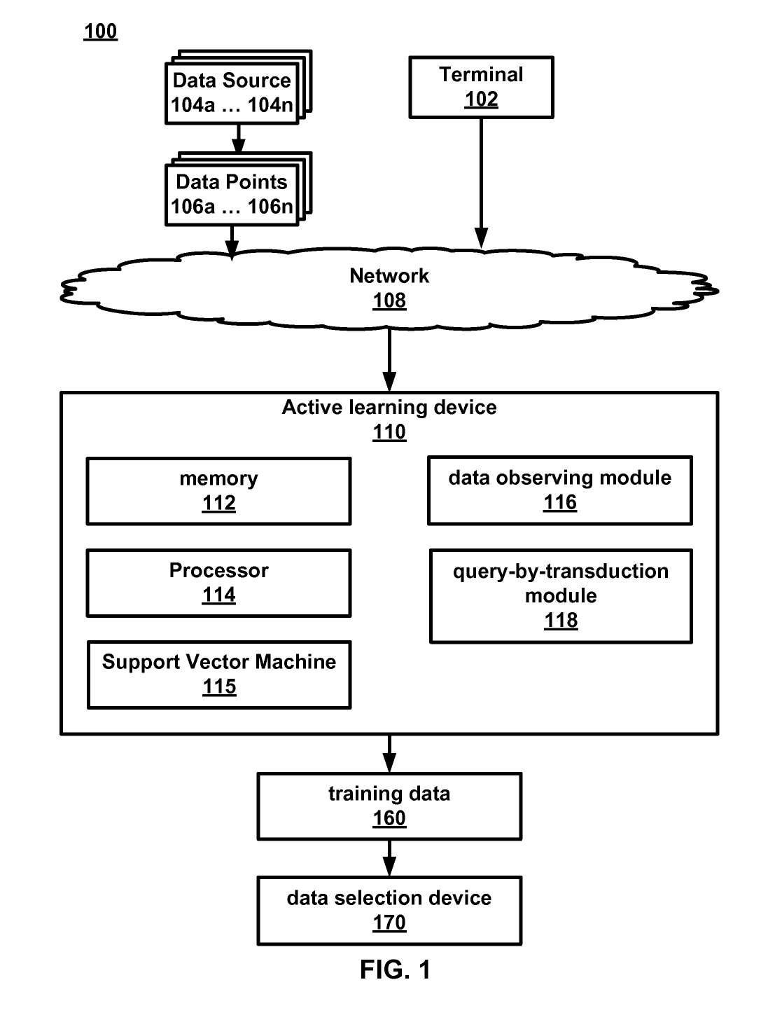

FIG. 1 illustrates an example active learning system 100 for generating an active learning training data set 160 according to various aspects of the embodiment. Active learning system 100 includes, for example, a terminal 102 coupled to an active learning device 110 via a network 108, through which active learning device 110 may receive data points 106a . . . 106n from data sources 104a . . . 104n. A user may interact with active learning system 100 using terminal 102. Active learning device 110 includes, among other things, at least one memory 112, at least one processor 114, a data observing module 116, and a query-by-transduction (QBT) module 118. Through these components, active learning device 110 may generate and use training data 160 by learning from and modeling data points 106a . . . 106n.

According to various aspects of the embodiment, active learning device 110 may use data observing module 116 to observe (i.e., receive and/or select) data points 106a . . . 106n from data sources 104a . . . 104n. Data sources 104a . . . 104n may be streaming and/or pooled, as appropriate. In other words, data points 106a . . . 106n may be streaming data and/or be pooled data.

According to various aspects of the embodiment, at least one processor 114 may initialize a Support Vector Machine (SVM) 115. SVM 115 is a choice classifier that provides classifications of data within training data 160, thereby providing an analytical framework for classifying data points 106a . . . 106n. Training data 160 may be dynamically generated and trained as data points 106a . . . 106n are observed by data observing module 116 and may be selectively added to the training data 160. To generate training data 160, active learning device 110 may initialize SVM 115 with training data 160 that includes an initial set of data points, from which classifications of the initial set of data points are generated.

Using the analytical framework provided by SVM 115, QBT module 118 generates training data 160 by, among other things, selectively adding observed data points 106a . . . 106n to training data 160. QBT module 118 selectively adds a data point(s) 106a . . . 106n to the training data 160 when the data point(s) 106a . . . 106n is interesting. Data point(s) 106a . . . 106n may be interesting when an uncertainty exists regarding whether the data point(s) 106a . . . 106n belongs to one of at least two classifications within the analytical framework provided by SVM 115. Such uncertainty suggests that the data point(s) 106a . . . 106n belong to a new classification of data, thereby enriching training data 160 with the new classification. Thus, active learning system 100 may learn from a data point(s) 106a . . . 106n that is interesting because the data point(s) 106a . . . 106n may represent a new classification of data. QBT module 118 may generate training data 160 until terminated as appropriate when indicated by a stopping threshold.

According to an embodiment of the embodiment, once generated, training data 160 may be used to identify particular data among a plurality of data points (not shown) that may be important or otherwise relevant for a particular field. For example, data selection device 170 may use training data 160, trained on a particular field, to identify important information from among a diverse or otherwise large body of information. In particular, data selection device 170 may use training data 160 to mine medical databases and/or other health records of patients (not shown) in order to identify which medical information is relevant for particular patients, particular diseases, diagnoses, and/or other particular fields. A healthcare professional may use data selection device 170 to mine a patient's medical record and select data from the medical record that may be important for diagnosing the patient, for example. In this manner, training data 160 may be trained on a variety of fields in order to identify important information for each field.

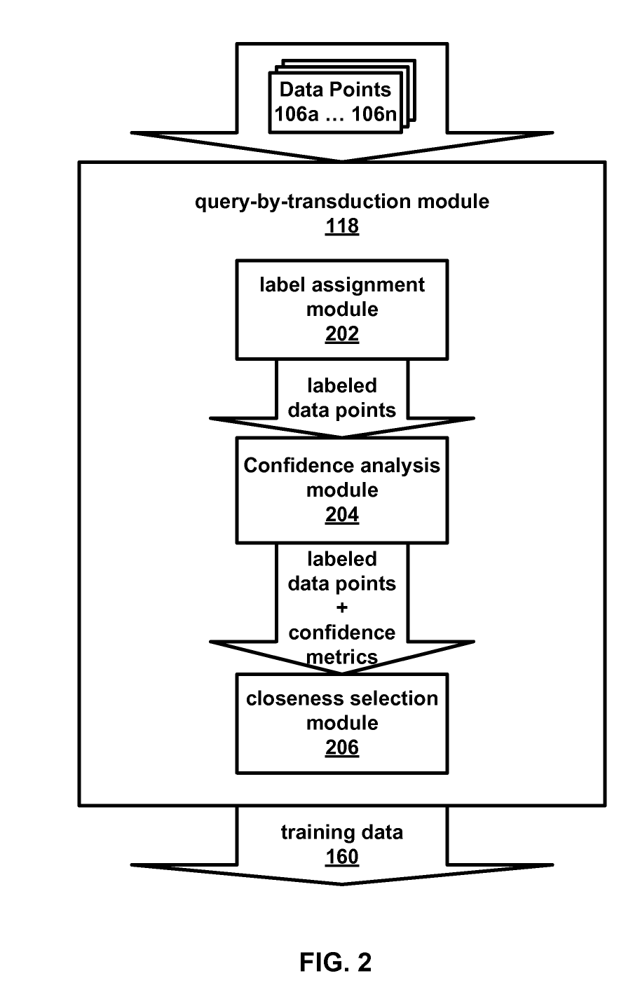

FIG. 2 is a block diagram of an example QBT module 118 that determines whether a data point(s) 106a . . . 106n are interesting, according to various aspects of the embodiment. QBT module 118 may include, among other things, a label assignment module 202, a confidence analysis module 204, and a closeness selection module 206.

According to various aspects of the embodiment, label assignment module 202 may assign a plurality of labels to an observed data point(s) 106a . . . 106n according to classifications of the training data 160 from SVM 115. Each label may indicate a classification of the observed data point(s) 106a . . . 106n from among classifications of training data 160. In other words, label assignment module 202 may assign labels to the observed data point(s) 106a . . . 106n. Each label predicts a possible classification of the observed data point(s) 106a . . . 106n based on the analytical framework provided by SVM 115. For example, if the training data 160 includes data that is classified according to nine classifications, nine labels (one for each classification) may be assigned for an observed data point(s) 106a . . . 106n that predicts that the observed data point(s) 106a . . . 106n belongs to one of nine respective classifications. Other examples are contemplated and the foregoing is an example only. For example, any number of classification may exist within training data 160 and all or at least a portion of the classifications may be predicted for observed data point(s) 106a . . . 106n by a respective label as appropriate.

According to various aspects of the embodiment, confidence analysis module 204 may determine a confidence metric for each of the assigned labels using SVM 115. The confidence metric may indicate a level of confidence that a corresponding assigned label predicts a classification for the observed data point(s) 106a . . . 106n. According to various aspects of the embodiment, the confidence metric is a p-value, which may be calculated using a measure of strangeness. Strangeness is a measure of how much a data point(s) 106a . . . 106n is different from other data points.

According to various aspects of the embodiment, strangeness (and therefore a p-value) may be determined based on the analytical framework provided by SVM 115. For example, given training data 160: {(x₁,y₁),(x_{2,}y₂), . . . ,(xₙ,yₙ)}, where yᵢ ∈ {−1,1}, SVM 115 seeks the separating hyperplane that yields a maximal margin for the separable case, i.e., the set of training data 160 is separated without error and the distance between the closest training data 160 and the hyperplane may be maximal. For a nonseparable case, the margin may be maximized with minimum loss in misclassification. When an unknown instance xₙ₊₁ is included with a potential label yₙ₊₁=y* into training data 160, Lagrange multipliers α₁,α₂, . . . αₙ,αₙ₊₁ associated with the data in training data 160 and (xₙ₊₁,y*) as the strangeness measure using SVM 115. The Lagrange multipliers αᵢ, i=1, . . . , n+1 may be found by maximizing the dual formulation of a soft-margin SVM 115, which may be expressed as:

$$Q ( α ) = - 1 / 2 {\sum }_{i = 1}^{n + 1} {\sum }_{j = 1}^{n + 1} {α}_{i} {α}_{j} {y}_{i} {y}_{j} K ( {x}_{i} , {x}_{j} ) + {\sum }_{i = 1}^{n + 1} {α}_{i} \qquad ( 1 )$$

subject to the constraints

$${\sum }_{i = 1}^{n + 1} {α}_{i} {y}_{i} = 0$$

and 0≦αᵢ≦C, i=1, . . . ,n+1, where K(.) is a kernel function. Strangeness and the Lagrange multipliers may be related where sets of training data 160 outside the margin have zero Lagrange multipliers. For the sets of training data 160 on the margin, the values of the Lagrange multiplier are between 0 and C. Sets of training data 160 within the margin may have the Lagrange multiplier value C. The sets of training data 160 within the margin are more strange as compared to sets of training data 160 that are outside the margin.

According to various aspects of the embodiment, a p-value function generating p-values may be generated based on strangeness. For example, if xₙ₊₁ is an observed data point(s) 106a . . . 106n and αₙ₊₁^{y} is the strangeness of observed data point(s) 106a . . . 106n for an assigned label y*, then t((x₁,y₁),(x₂,y₂), . . . , (xₙ₊₁, y*)) may be the p-value of xₙ₊₁ for the assigned label y*, given training data 160 {(x₁,y₁),(x₂,y₂), . . . , (xₙ,yₙ)}. In this example, a p-value function t:Xⁿ⁺¹→[0,1] may be expressed as:

t((x₁,y₁),(x₂,y₂), . . . , (xₙ₊₁,y*))=#{i=1, . . . , n:αᵢ>=αₙ₊₁^{y}}/n (2).

According to various aspects of the embodiment, confidence metrics of assigned labels may be analyzed to determine whether observed data point(s) 106a . . . 106n are interesting. As previously noted, data point(s) 106a . . . 106n may be interesting when an uncertainty exists regarding whether the data point(s) 106a . . . 106n belongs to one of at least two classifications within the analytical framework of SVM 115. According to various aspects of the embodiment, closeness selection module 206 may determine a closeness metric, which is a measure of uncertainty, among at least two assigned labels for the observed data point(s) 106a . . . 106n based on their respective confidence metrics. An uncertainty exists regarding whether the observed data point(s) 106a . . . 106n belongs to a first classification or a second classification when a difference between first and second confidence metrics is small. In other words, uncertainty increases as the difference between at least two confidence metrics approaches zero.

Three cases may exemplify determining whether an uncertainty exists between two labels, “j” and “k,” assigned to observed data point(s) 106a . . . 106n, according to their respective confidence metrics Pⱼ and Pₖ. In these examples, labels j and k predicts that observed data point(s) 106a . . . 106n belong to classifications “j” and “k,” respectively. Confidence metrics Pⱼ and Pₖ are levels of confidence that label j and label k plausibly predict classifications for the observed data point(s) 106a . . . 106n, respectively.

Case 1: Pⱼ is high and Pₖ is low.

Case 2: Pⱼ is high and Pₖ is high.

Case 3: Pⱼ is low and Pₖ is low.

Cases 2 and 3 may indicate a data point(s) 106a . . . 106n that is interesting. In cases 2 and 3, there exists is a level of uncertainty whether labels j and k predict a classification for data point(s) 106a . . . 106n. Case 1 may indicate that data point(s) 106a . . . 106n is not interesting because there may exist a high level of certainty that label j predicts that data point(s) 106a . . . 106n belongs to classification j. These cases are examples and an indication of “high” and “low” confidence metrics are not dispositive.

According to various aspects of the embodiment, closeness selection module 206 may determine a closeness score between confidence metrics Pⱼ and Pₖ that measures a level of closeness between confidence metrics Pⱼ and Pₖ. The closeness score may be expressed as:

Pⱼ−Pₖ (3)

Closeness selection module 206 may compare the closeness score to a selection threshold. When the closeness score is less than the selection threshold, data point(s) 106a . . . 106n may be determined to be interesting and added to training data 160.

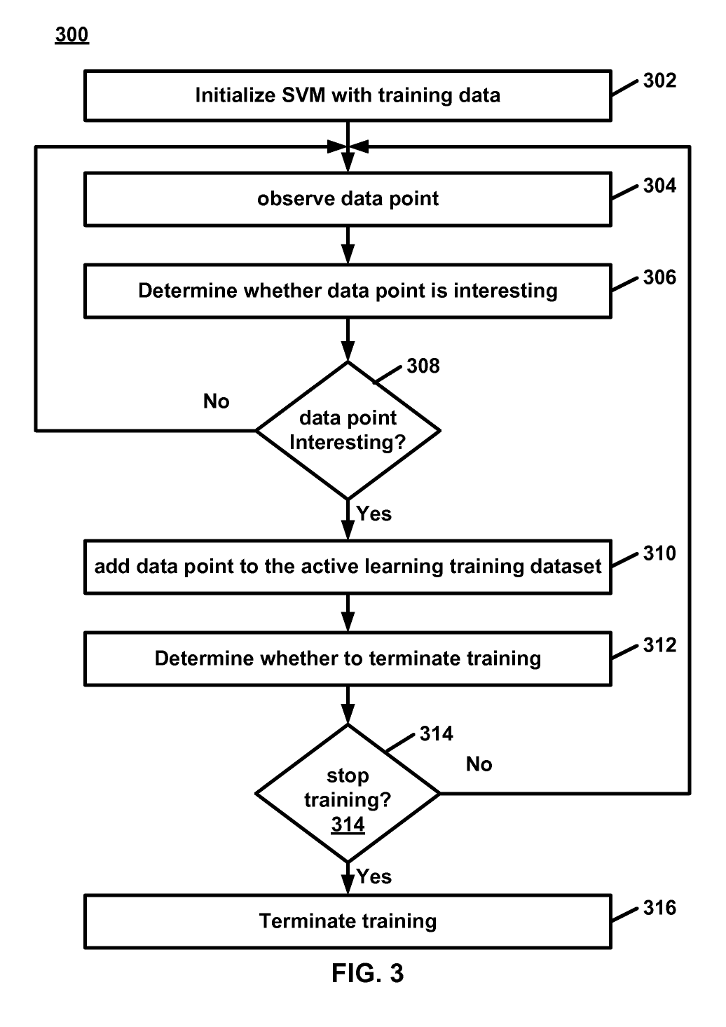

FIG. 3 is a flow diagram of an example process 300 for generating training data 160 according to various aspects of the embodiment. The various processing operations depicted in the flow diagram of FIG. 3 (and in the other drawing figures) are described in greater detail herein. The described operations for a flow diagram may be accomplished using some or all of the system components described in detail above and, in some implementations, various operations may be performed in different sequences. In other implementations, additional operations may be performed along with some or all of the operations shown in the depicted flow diagrams. In yet other implementations, one or more operations may be performed simultaneously. Accordingly, the operations as illustrated (and described in greater detail below) are examples and, as such, should not be viewed as limiting.

According to one aspect of the embodiment, SVM 115 may be initialized with training data 160 that includes an initial set of data points that are classified in an operation 302. In an operation 304, at least one data point(s) 106a . . . 106n may be observed. Data point(s) 106a . . . 106n may be interesting and may enrich the classifications included in training data 160. As such, in an operation 306, a determination may be made whether data point(s) 106a . . . 106n is interesting. If in an operation 308, data point(s) 106a . . . 106n is not interesting, processing may return to operation 304, wherein another data point(s) 106a . . . 106n is observed.

Returning to operation 308, if data point(s) 106a . . . 106n is determined to be interesting, data point(s) 106a . . . 106n may be added to training data 160 in an operation 310. Upon adding data point(s) 106a . . . 106n to training data 160 in operation 310, training data 160 may include sufficient data points 106. As such, in an operation 312, a determination is made whether training is complete. If in an operation 314 training is determined to be incomplete, a new data point(s) 106a . . . 106n may be observed in operation 304. If in operation 314 training is complete, training may be terminated in an operation 316, wherein training data 160 may be used to classify data.

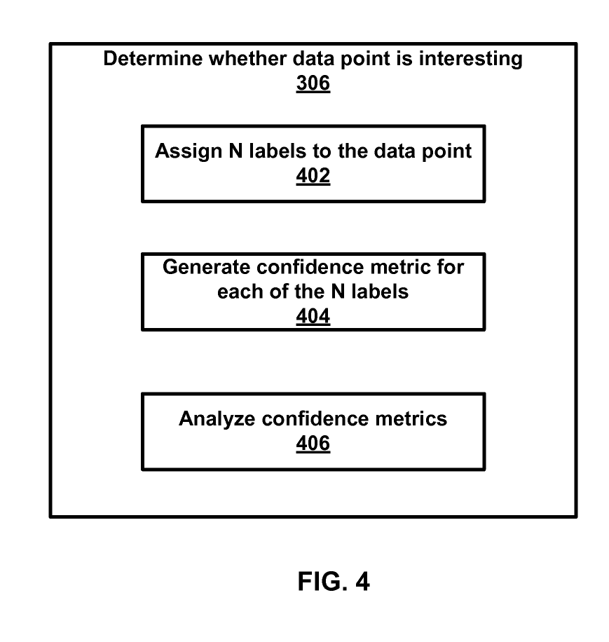

FIG. 4 is a flow diagram of an example process 306 for determining whether a data point(s) 106a . . . 106n is interesting according to various aspects of the embodiment. In an operation 402, a number of labels may be assigned to data point(s) 106a . . . 106n. The number of labels may respectively predict a classification of data from training data 160. In other words, each assigned label may represent a prediction that data point(s) 106a . . . 106n belongs to a particular classification of data. As such, in an operation 404, a confidence metric may be generated for each assigned label in order to indicate a level of confidence that the label accurately predicts a classification for data point(s) 106a . . . 106n. In an operation 406, the generated confidence metrics may be analyzed to determine whether there exists uncertainty regarding whether assigned labels accurately predict respective classifications. As previously noted, data point(s) 106a . . . 106n may be interesting when there exists a level of uncertainty regarding assigned labels that predict classifications of data point(s) 106a . . . 106n.

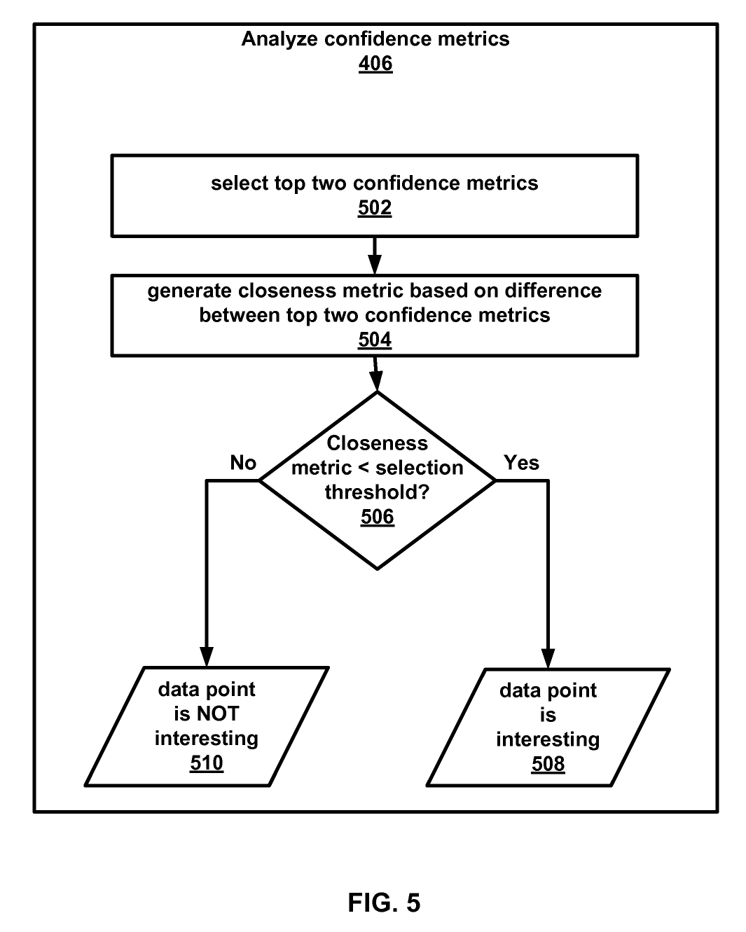

FIG. 5 is a flow diagram of an example process 406 for analyzing confidence metrics according to various aspects of the embodiment. In an operation 502, the highest confidence metrics may be selected for comparison. In an operation 504, a closeness metric may be generated by generating a difference between the highest confidence metrics. For example, when p-values are used for confidence metrics, a measure of closeness between confidence metrics Pⱼ and Pₖ may be determined by Equation 3 as previously discussed.

In an operation 506, a determination may be made whether the closeness metric is below a selection threshold. The selection threshold may be predefined or otherwise configurable. When the closeness score is less than the selection threshold, data point(s) 106a . . . 106n may be determined to be interesting and added to training data 160. As previously noted, data point(s) 106a . . . 106n is interesting when an uncertainty exists regarding whether the data point(s) 106a . . . 106n belongs to one of at least two classifications within the analytical framework of SVM 115. In other words, uncertainty increases as the difference between at least two confidence metrics approaches zero. The selection threshold may be predefined or otherwise configurably defined in order to set a level of certainty above which data point(s) 106a . . . 106n is deemed to be not interesting. In other words, the selection threshold may be used to set a threshold level of uncertainty in order to define which data points 106a . . . 106n are not interesting.

If in operation 506, the closeness metric is less than the selection threshold, data point(s) 106a . . . 106n is determined to be interesting in an operation 508 because as the closeness metric approaches zero, greater uncertainty regarding whether data point(s) 106a . . . 106n belongs to classifications respectively predicted by labels corresponding to teach of the top two confidence metrics. If in operation 506, the closeness metric exceeds the selection threshold, then data point(s) 106a . . . 106n may be determined to be not interesting in an operation 510.

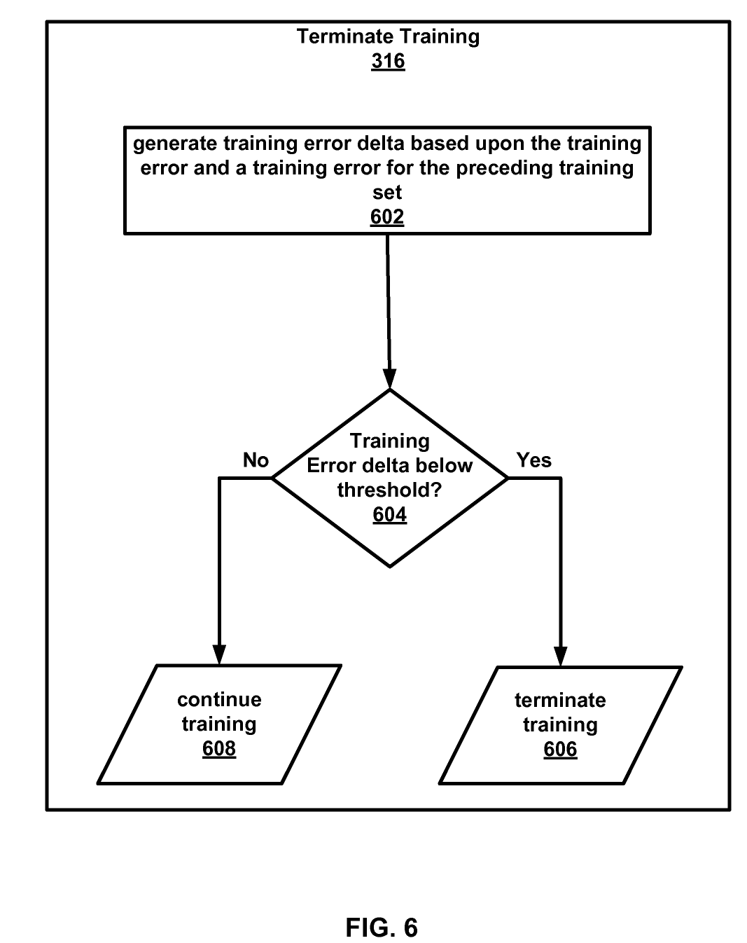

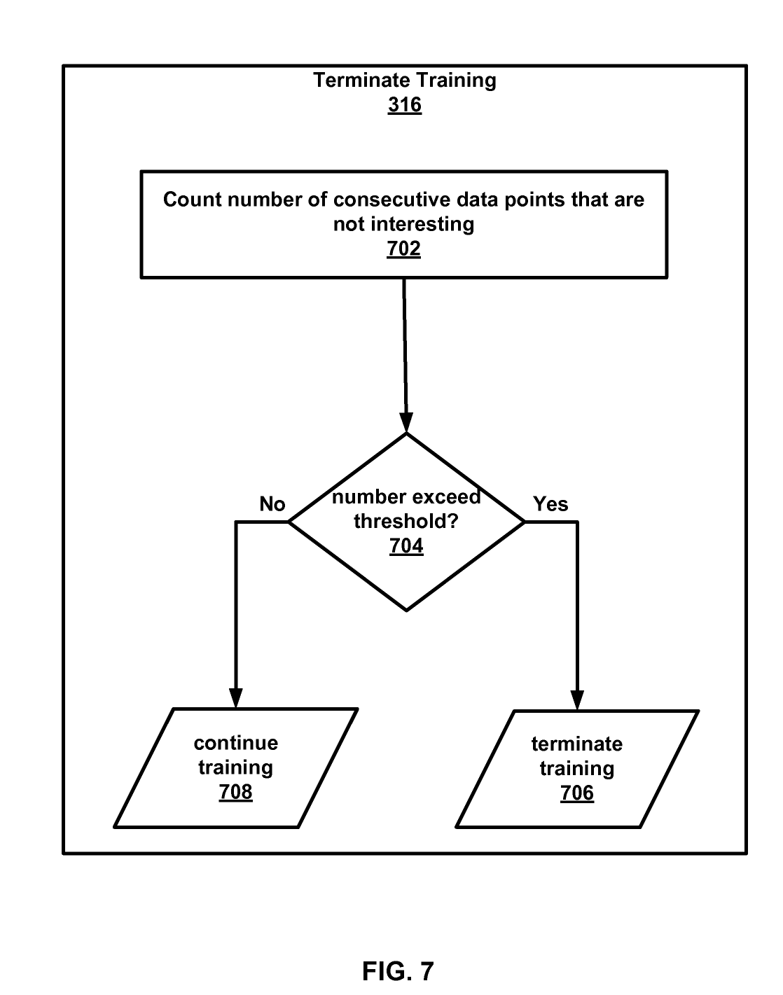

FIGS. 6 and 7 are flow diagrams of different embodiments of process 316 for terminating generation of training data 160, according various embodiments of the embodiment.

Referring to FIG. 6, a training error delta may be generated in an operation 602. The training error delta is a difference between first and second training errors. The first training error is calculated before a data point(s) 106a . . . 106n is added to training data 160 while the second training error is calculated after data point(s) 106a . . . 106n is added to training data 160. Thus, the training error delta may indicate a level of change in expected error of training data 160 before and after data point(s) 106a . . . 106n is added to training data 160. In an operation 604, a determination is made whether the training error delta exceeds an error threshold. The error threshold may be predefined or otherwise configurable. If in operation 604, the training error delta does not exceed an error threshold, a determination may be made to continue generation of training data 160 in an operation 606, wherein processing returns to operation 304. Alternatively, if in operation 604, the training error delta exceeds an error threshold, a determination is made to terminate generation of training data 160 in an operation 608, wherein generation of training data 160 is terminated in an operation 316.

Referring to FIG. 7, in an operation 702, a number of consecutive data points 106a . . . 106n that are determined to be not interesting may be counted. In an operation 704, a determination may be made regarding whether the count exceeds a count threshold. The count threshold may be predefined or otherwise configurable. If in operation 704 the count exceeds the count threshold, then in an operation 706, a determination is made to terminate generation of training data 160, wherein generation of training data 160 is terminated in an operation 316. Generation of training data 160 may be terminated if the count threshold is exceeded because exceeding the count threshold may indicate that data points 106 may no longer be found that are interesting (or the frequency of which is lower than acceptable as indicated by the count threshold). In other words, training data 160 may include a sufficient number of classifications of data based on data points 106 already added to training data 160. Alternatively, if in operation 704 the count does not exceed the count threshold, a determination is made to continue generation of training data 160 in an operation 708, wherein processing returns to operation 304.

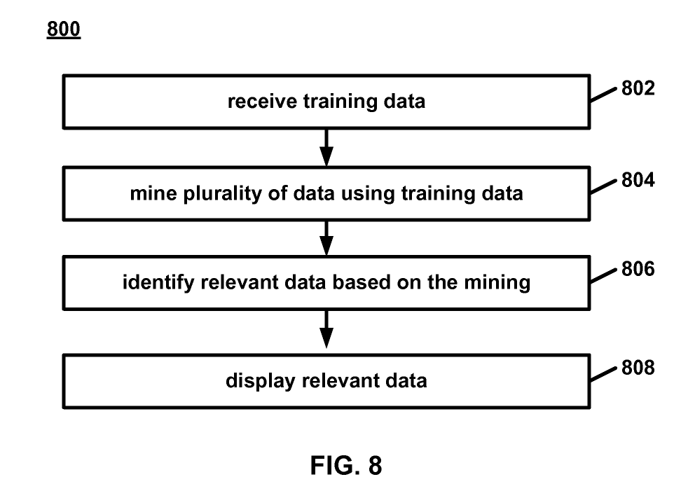

FIG. 8 is a flow diagram of a process for selecting relevant data from among a plurality of data points related to a particular field according to an aspect of the embodiment. Once generated, the training data 160 may be used to determine which data is relevant or otherwise important. For example, in an operation 802, training data 160 may be received. The received training data 160 may have been trained on a particular field of data. Having been trained on the particular field of data, training data 160 may be used to determine information in that particular field of data is important. In an operation 804, a plurality of data from the particular field may be mined using training data 160. For example, the classifications of data within training data 160 may be used in order to identify relevant data in an operation 806. For example, the particular field may be medicine, where training data 160 has been trained on medical data from medical repositories, medical records of patients, and/or other medical data. Having been trained using medical data, for example, training data 160 may be able to identify various classifications of medical data important for identifying important information such as, for example, which symptoms are important for various diseases, which patients may be predisposed to certain ailments based on their medical record as compared to the training data 160, and/or other important information. Once identified using training data 160, the relevant data may be displayed in an operation 808. For example, data selection device 170 may display relevant medical data to a healthcare professional that used training data 160, trained on medical data, in order to enhance medical care for a patient. In this manner, training data 160 may be used to facilitate diagnosis, prognosis, and general treatment of patients when medical records are mined using training data 160 that was trained on medical data according various embodiments of the embodiment.

According to an aspect of the embodiment, active learning device 110 may be accessible over a network 108, via any wired or wireless communications link, using one or more user terminals 102. Network 108 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), or other network. Examples of terminal 102 may include any one or more of, for instance, a personal computer, portable computer, personal digital assistant (PDA), workstation, web-enabled mobile phone, WAP device, web-to-voice device, or other device. Those having skill in the art will appreciate that the embodiment described herein may work with various system configurations.

In this specification, “a” and “an” and similar phrases are to be interpreted as “at least one” and “one or more.”

Many of the elements described in the disclosed embodiments may be implemented as modules. A module is defined here as an isolatable element that performs a defined function and has a defined interface to other elements. The modules described in this disclosure may be implemented in hardware, software, firmware, wetware (i.e., hardware with a biological element) or a combination thereof, all of which are behaviorally equivalent. For example, modules may be implemented as a software routine written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies are often used in combination to achieve the result of a functional module.

The disclosure of this patent document incorporates material which is subject to copyright protection. The copyright owner has no objection to the facsimile reproduction by anyone of the patent document or the patent disclosure, as it appears in the Patent and Trademark Office patent file or records, for the limited purposes required by law, but otherwise reserves all copyright rights whatsoever.

In addition, implementations of the embodiment may be made in hardware, firmware, software, or any suitable combination thereof. Aspects of the embodiment may also be implemented as instructions stored on a machine-readable medium, which may be read and executed by one or more processors. A machine-readable medium may include any mechanism for storing or transmitting information in a form readable by a machine (e.g., a computing device). For example, a machine-readable storage medium may include read only memory, random access memory, magnetic disk storage media, optical storage media, flash memory devices, and others, and a machine-readable transmission media may include forms of propagated signals, such as carrier waves, infrared signals, digital signals, and others. Further, firmware, software, routines, or instructions may be described herein in terms of specific example aspects and implementations of the embodiment, and performing certain actions. However, it will be apparent that such descriptions are merely for convenience and that such actions in fact result from computing devices, processors, controllers, or other devices executing the firmware, software, routines, or instructions.

Aspects and implementations described herein as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other aspects or implementations, whether or not explicitly described. Thus, various changes and modifications may be made to the provided description without departing from the scope or spirit of the embodiment. As such, the specification and drawings should be regarded as examples only, and the scope of the embodiment to be determined solely by the appended claims.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on using p-values for confidence metrics. However, one skilled in the art will recognize that embodiments of the invention could be any other confidence metric.

In addition, it should be understood that any figures which highlight the functionality and advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A computer readable storage medium storing computer executable instructions for generating an active learning training dataset, the instructions configuring one or more processors when executed to:
a) receive at least one data point from a data source;
b) assign a plurality of labels to the at least one data point, wherein each label predicts a classification of the at least one data point;
c) generate a plurality of confidence metrics, wherein each confidence metric corresponds to each label, and wherein each confidence metric indicates a level of confidence that the corresponding label predicts a classification of the at least one data point;
d) analyze the plurality of confidence metrics;
e) determine whether the at least one data point is interesting based on the analysis; and
f) add the at least one data point to the active learning training dataset when the at least one data point is determined to be interesting.

2. The computer readable storage medium of claim of claim 1, wherein when executing the process of analyze the plurality of confidence metrics, the instructions further configuring one or more processors when executed to:
a) determine at least two confidence metrics having the highest confidence;
b) generate a closeness score between the at least two confidence metrics; and
c) determine that the at least one data point is interesting when the closeness score is less than a selection threshold.

3. The computer readable storage medium of claim 1, the instructions further configuring one or more processors when executed to iterate the receive, assign, analyze, determine, and add until a stopping threshold is reached.

4. The computer readable storage medium of claim 3, wherein the stopping threshold is a predefined training error threshold, the instructions further configuring one or more processors when executed to:
a) determine a first training error for the active learning training dataset prior to adding the at least one data point;
b) determine a second training error for the active learning training dataset after adding the at least one data point;
c) determine a delta between the first training error and the second training error; and
d) determine the stopping threshold is reached when the delta reaches the training error threshold.

5. The computer readable storage medium of claim 3, wherein the stopping threshold is a number of consecutive data points that have been determined to be not interesting.

6. The computer readable storage medium of claim 1, wherein the data source is a pool of data.

7. The computer readable storage medium of claim 1, wherein the data source is streaming.

8. A computer readable storage medium storing computer executable instructions for determining whether at least one data point is interesting, the instructions configuring one or more processors when executed to:
a) assign a plurality of labels to the at least one data point, wherein each label predicts a classification of the at least one data point;
b) generate a plurality of confidence metrics, wherein each confidence metric corresponds to each label, and wherein each confidence metric indicates a level of confidence that the corresponding label predicts a classification of the at least one data point;
c) analyze the plurality of confidence metrics; and
d) determine whether the at least one data point is interesting based on the analysis.

9. The computer readable storage medium of claim 8, wherein when executing the process of analyze the plurality of confidence metrics, the instructions further configuring one or more processors when executed to:
a) determine at least two confidence metrics having the highest confidence;
b) generate a closeness score between the at least two confidence metrics; and
c) determine that the at least one data point is interesting when the closeness score is less than a selection threshold.

10. A system for generating an active learning training dataset, comprising:
a) a memory for storing a Support Vector Machine (SVM);
b) one or more processors configured to initialize the SVM;
c) a data observing module configured to receive at least one data point from a data source;
d) a Support Vector Machine (SVM) module configured to generate a plurality of confidence metrics; and
e) a query-by-transduction module configured to:
i) assign a plurality of labels to the at least one data point, wherein each label predicts a classification of the at least one data point, and wherein each confidence metric generated by the SVM module corresponds to each label, and wherein each confidence metric indicates a level of confidence that the corresponding label predicts a classification of the at least one data point;
ii) analyze the plurality of confidence metrics; and
iii) determine whether the at least one data point is interesting based on the analysis.

11. The system of claim of claim 10, wherein when executing the process of analyze the plurality of confidence metrics, the query-by-transduction module is further configured to:
a) determine at least two confidence metrics having the highest confidence;
b) generate a closeness score between the at least two confidence metrics; and
c) determine that the at least one data point is interesting when the closeness score is less than a selection threshold.

12. The system of claim 10, wherein the query by transduction module is further configured to iterate the receive, assign, analyze, determine, and add until a stopping threshold is reached.

13. The system of claim 12, wherein the stopping threshold is a predefined training error threshold, the query-by-transduction module further configured to:
a) determine a first training error for the active learning training dataset prior to adding the at least one data point;
b) determine a second training error for the active learning training dataset after adding the at least one data point;
c) determine a delta between the first training error and the second training error; and
d) determine the stopping threshold is reached when the delta reaches the training error threshold.

14. The system of claim 12, wherein the stopping threshold is a number of consecutive data points that have been determined to be not interesting.

15. The system of claim 10, wherein the data observing module is configured to receive data from a pool of data.

16. The system of claim 10, wherein the data observing module is configured to receive data from streaming data.

17. A system for determining whether at least one data point is interesting, comprising:
a) a memory for the at least one data point;
b) a Support Vector Machine (SVM) module configured to generate a plurality of confidence metrics; and
c) a query-by-transduction module configured to:
i) assign a plurality of labels to the at least one data point, wherein each label predicts a classification of the at least one data point, and wherein each confidence metric corresponds to each label, and wherein each confidence metric indicates a level of confidence that the corresponding label predicts a classification of the at least one data point;
ii) analyze the plurality of confidence metrics; and
iii) determine whether the at least one data point is interesting based on the analysis.

18. The system of claim 17, wherein when executing the process of analyzing the plurality of confidence metrics, the query-by-transduction module is further configured to:
a) determine at least two confidence metrics having the highest confidence;
b) generate a closeness score between the at least two confidence metrics; and
c) determine that the at least one data point is interesting when the closeness score is less than a selection threshold.

19. A computer readable storage medium storing computer executable instructions for selecting relevant data from among a plurality of data points related to a particular field, the instructions configuring one or more processors when executed to:
a) receive, by the data selection device, training data that was trained on the particular field;
b) mine by the data selection device, the plurality of data points using the training data; and
c) identify by the data selection device, the relevant data based on the mining.

20. The computer readable storage medium of claim 19, wherein the particular field is medicine and the plurality of data points comprise data from one or more medical records, and wherein the instructions when executed further configuring one or more processors to:
a) determine, by the data selection device, diagnostic data among the one or more medical records that is relevant for diagnosing a particular disease; and
b) display the diagnostic data.
